(19) United States
(12) Patent Application Publication
(10) Pub. No.: US 2009/0055638 A1
(43) Pub. Date: Feb. 26, 2009

(54) Algorithm update system

(76) Inventors: Toshihisa Nakano, Osaka (JP); Natsume Matsuzaki, Osaka (JP); Shinichi Marui, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/918,656

(22) PCT Filed: Apr. 21, 2006
(86) PCT No.: PCT/JP2006/308438

§ 371 Date: Oct. 17, 2007

(30) Foreign Application Priority Data
Apr. 21, 2005 (JP) 2005-123221

(51) Int. Cl. G06F 15/177; G06F 17/30

(52) U.S. Cl. 713/1; 707/200; 707/10; 707/E17.005

(57) ABSTRACT

A design data storage unit stores a plurality of pieces of design data. A judgment unit 203 judges whether a circuit for decrypting an encrypted content received from a content server 10 is realized in a reconfigurable unit 208, and judges whether a piece of the design data for realizing the circuit for decrypting the encrypted content is held. If the desired circuit is not realized in the reconfigurable unit 208 and the desired piece of the design data is not held, the desired piece of the design data is acquired from a design data server 30 via a network.

### TECHNICAL FIELD

The present invention relates to an art for updating an encryption scheme hardware-implemented in an apparatus.

### BACKGROUND ART

Generally, contents distributed via a network or contents recorded in recording media are encrypted before distribution in order to prevent malicious use of the contents and protect copyrights thereof.

In apparatuses for playing back the contents, decryption processing is performed to decrypt the encrypted contents. In most cases, encryption schemes are hardware-implemented in view of requested processing speed and tamper-resistance.

Here, there is a demand that if secret information relating to encryption processing is revealed, an encryption scheme implemented in an apparatus is updated to a new encryption scheme to maintain security. Recently, with use of reconfigurable devices such as an FPGA (Field Programmable Gate Array) and a PLA (Programmable Logic Array), update of hardware-implemented encryption schemes have become possible (See Japanese Patent Application Publication No. H10-320191).

Also, Japanese Patent Application Publication No. H10-055135 discloses an art in which a database for storing encryption algorithm files is held in an apparatus, any one of the encryption algorithm files is acquired from the database to update an encryption algorithm hardware-implemented in the apparatus, in accordance with an external instruction.

### Problems the Invention is Going to Solve

However, the above conventional arts have a problem that new encryption algorithms that are not stored in a database included within an apparatus cannot be supported.

The present invention was conceived in view of the problem described above, and aims to provide an algorithm updating system capable of updating new encryption algorithms that are not stored in a database within an apparatus.

### Means to Solve the Problems

In order to achieve the above object, the present invention provides a content use apparatus comprising: a reconfigurable unit operable to configure a circuit based on a piece of design data; a first judgment unit operable to judge whether a content use circuit has been configured in the reconfigurable unit, the content use circuit realizing a function relating to use of a content; a second judgment unit operable to judge whether content use design data for configuring the content use circuit has been stored; and an acquisition unit operable, if the first judgment unit and the second judgment unit judge negatively, to acquire the content use design data from outside, wherein the reconfigurable unit configures the content use circuit based on the acquired content use design data.

### EFFECT OF THE INVENTION

Here, the above “reconfigurable unit” corresponds to a reconfigurable unit 208 in an embodiment which is described later. Functions of the “first judgment unit” and the “second judgment unit” are achieved by a judgment unit 203 in the embodiment. Functions of the “acquisition unit” are achieved by a transmission/reception unit 201 and a design data reading/writing unit 204 in the embodiment.

According to the above structure, if a circuit is not configured in the reconfigurable unit and a piece of design data to be used for circuit configuration is not held, the content use apparatus acquires the piece of the design data from outside to configure the circuit. Therefore, a new circuit can be configured in the reconfigurable unit.

Also, if a content use circuit has been already configured in the reconfigurable unit, configuration of the content use circuit is unnecessary. If content use design data has been already held, acquisition of the content use design data from outside is unnecessary. Therefore, judgments performed by the first judgment unit and the second judgment unit allow efficient circuit configuration.

Here, the content use apparatus further may comprise a design data storage unit operable to store pieces of the design data for configuring circuits that realize functions relating to use of the content, wherein the second judgment unit may perform the judgment by judging whether the content use design data has been stored in the design data storage unit.

According to this structure, the content use apparatus can store therein a plurality of pieces of design data, and acquires a piece of design data that is not stored in the design data storage unit from outside so as to configure a new circuit in the reconfigurable unit.

Here, the functions may include encryption of the content and decryption of an encrypted content generated by encrypting the content, and the content use circuit may realize the encryption and the decryption.

According to this structure, the content use apparatus is an apparatus that performs encryption processing and/or decryption processing of contents. For example, suppose that secret information relating to the encryption processing is revealed, and a request occurs for updating an encryption scheme implemented in the content use apparatus to a new encryption scheme to maintain security. Even if not holding therein a piece of design data relating to the new encryption scheme, the content use apparatus can configure a circuit corresponding to the new encryption scheme in the reconfigurable unit by acquiring the relating piece of design data from outside.

Here, the content use apparatus may be connected with an external design data server via a network, wherein the acquisition unit may acquire the content use design data from the design data server.

According to this structure, if being in an environment where connection to a network is possible, the content use apparatus can acquire the content use design data from the design data server via the network.

Here, the content use apparatus may be connected with an external content server via a network, and may receive, from the content server, a design data identifier for uniquely identifying the content and the content use design data, wherein the acquisition unit may output the design data identifier to request the design data server to transmit the content use design data, and the reconfigurable unit may configure, based on the acquired content use design data, the content use circuit that realizes decryption of an encrypted content generated by encrypting the content.

According to this structure, the content use apparatus can acquire, from the design data server, a piece of the design data corresponding to the encrypted content received from the content server.

Here, the content use apparatus may further comprise a medium input unit operable to read information from a recording medium, wherein the acquisition unit may acquire the content use design data stored in the recording medium via the medium input unit.

According to this structure, the content use apparatus directly reads the content use design data from the recording medium without communication via the network, and therefore can securely acquire the content use design data.

Here, the functions may include encoding of the content and decoding of an encoded content generated by encoding the content, and the content use circuit may realize the encoding or the decoding.

According to this structure, the content use apparatus is an apparatus that performs encoding processing and/or decoding processing of contents, and can update a plurality of encoding/decoding algorithms by storing therein a plurality of pieces of design data. Furthermore, even if not holding therein a piece of design data relating to a new encoding/decoding algorithm that is not held therein, the content use apparatus can configure a new encoding/decoding circuit in the reconfigurable unit by acquiring the piece of the design data from outside.

Here, the design data storage unit may store a design data table having the pieces of the design data arranged therein, if acquiring the content use design data, the acquisition unit may write the acquired content use design data into the design data table, the content use apparatus may further comprise: a deletion judgment unit operable to judge whether to delete any piece of the design data based on a data size of the design data table; and a design data deletion unit operable, if the deletion judgment unit judges affirmatively, to select a piece of the design data to be deleted, and delete the selected piece of the design data.

According to this structure, each time the acquisition unit acquires a new piece of content use design data, a data amount of the design data table increases. However, with inclusion of the deletion judgment unit and the deletion unit, the content use apparatus can prevent the data amount of the design data table from exceeding a storage capacity of the design data storage unit.

Here, the design data table may store pieces of design data use information in one-to-one correspondence to the pieces of the design data, each of the pieces of the design data use information showing a use frequency that a corresponding piece of the design data is used for circuit configuration, and if the deletion judgment unit judges affirmatively, the design data deletion unit may select, as the piece of the design data to be deleted, a piece of the design data corresponding to a piece of the design data use information showing the lowest use frequency, by reading the pieces of the design data use information.

Furthermore, if the deletion judgment unit judges affirmatively, the design data deletion unit may preferentially select, as the piece of the design data to be deleted, a piece of the design data corresponding to a piece of the design data use information showing a use frequency no less than a predetermined value, by reading the pieces of the design data use information.

According to this structure, it is possible to preferentially delete a piece of design data having a lower possibility of being requested for use for circuit configuration in the reconfigurable unit.

Here, the design data storage unit may store a design data table having the pieces of the design data arranged therein, if acquiring the content use design data, the acquisition unit may write the acquired content use design data into the design data table, the content use apparatus may further comprise: an update unit operable, if the content use circuit is configured in the reconfigurable unit, to rearrange the pieces of the design data included in the design data table.

According to this structure, the update unit can manage the use frequency of the pieces of the design data, while reducing the data amount of the design data table without writing information relating to the use frequency into the design data table, for example.

Here, the content use apparatus may further comprise: a deletion judgment unit operable to judge whether to delete any piece of the design data based on a data size of the design data table; and a design data deletion unit operable, if the deletion judgment unit judges affirmatively, to delete a predetermined number of the pieces of the design data from the design data table in ascending order of priority.

According to this structure, each time the acquisition unit acquires a new piece of content use design data, a data amount of the design data table increases. However, with inclusion of the deletion judgment unit and the deletion unit, the content use apparatus can prevent the data amount of the design data table from exceeding a storage capacity of the design data storage unit.

Here, when a piece of the design data is used for configuring the content use circuit, the update unit may elevate, one level up in the design data table, a priority of the piece of the design data.

Furthermore, when a piece of the design data is used for configuring the content use circuit, the update unit may give a highest priority in the design data table to the piece of the design data.

According to this structure, it is possible to preferentially delete a piece of design data having a lower possibility of being requested for use for circuit configuration in the reconfigurable unit.

Here, the design data storage unit may comprise: a first storage unit operable to read the pieces of the design data at a first access speed; and a second storage unit operable to read the pieces of the design data at a second access speed higher than the first access speed, wherein the design data storage unit may store, in the first storage unit, a piece of the design data having a use frequency of circuit configuration in the reconfigurable unit that is no less than a predetermined value, and may store, in the second storage unit, a piece of the design data having the use frequency that is less than the predetermined value.

Furthermore, the design data storage unit may further store a design data table including the pieces of the design data in one-to-one correspondence to use frequencies thereof and storage locations thereof, and may move each of the pieces of the design data, in accordance with a corresponding use frequency, to a corresponding storage location between the first storage unit and the second storage unit.

According to this structure, the content use apparatus stores, in a storage unit having a higher access speed, a piece of design data having a higher possibility of being requested for use for circuit configuration in the reconfigurable unit, and stores, in a storage unit having a lower access speed, a piece of design data having a lower possibility of being requested for use for circuit configuration in the reconfigurable unit. Therefore, circuit configuration can be efficiently performed.

Here, the design data storage unit may further store a flag for identifying a piece of the design data used for configuring the content use circuit currently configured in the reconfigurable unit.

According to this structure, it is possible to simply identify a piece of design data used for a circuit currently configured in the reconfigurable unit. Therefore, processing relating to whether circuit configuration is necessary is accelerated.

### BRIEF DESCRIPTION OF THE DRAWINGS

FIG. 1 is a system structural diagram showing a structure of an algorithm update system 1;

FIG. 2 shows a data structure of a content table 100 stored in a content server 10;

FIG. 3 is a functional block diagram functionally showing a structure of a content use apparatus 20;

FIG. 4 shows a data structure of a design data table 300 stored in a design data storage unit 202 of the content use apparatus 20;

FIG. 5 shows a data structure of a design data table 300a;

FIG. 6 shows a data structure of a content key table 350 stored in a content key storage unit 209 of the content use apparatus 20;

FIG. 7 shows a data structure of a design data table 400 stored in a design data server 30;

FIG. 8 shows an overall operation of the algorithm update system 1, and continues in FIG. 9;

FIG. 9 shows the overall operation of the algorithm update system 1, and continues from FIG. 8;

FIG. 10 is a flow chart showing operations of design data table update processing performed by a design data reading/writing unit 204 of the content use apparatus 20;

FIG. 11 shows a data structure of a design data table 500, which is a modification of the design data table 300;

FIG. 12 shows a data structure of a design data table 500a, which is a modification of the design data table 300;

FIG. 13 is a flow chart showing operations of a modification of the design data table update processing; and

FIG. 14 shows a data structure of a design data table 600, which is a modification of the design data table 300.

### DESCRIPTION OF CHARACTERS

1: algorithm update system

10: content server

20: content use apparatus

21: TV

30: design data server

40: network

201: transmission/reception unit

202: design data storage unit

203: judgment unit

204: design data reading/writing unit

205: encryption processing unit

206: unique key storage unit

207: decryption unit

208: reconfigurable unit

209: content key storage unit

210: playback control unit

### BEST MODE FOR CARRYING OUT THE INVENTION

The following describes an algorithm update system 1 as an embodiment of the present invention, with reference to the drawings.

The algorithm update system 1 is a system in which a content use apparatus that acquires an encrypted content from a content server realizes a designated encryption algorithm using a reconfigurable circuit to decrypt the encrypted content and play back the decrypted content.

### <Structure>

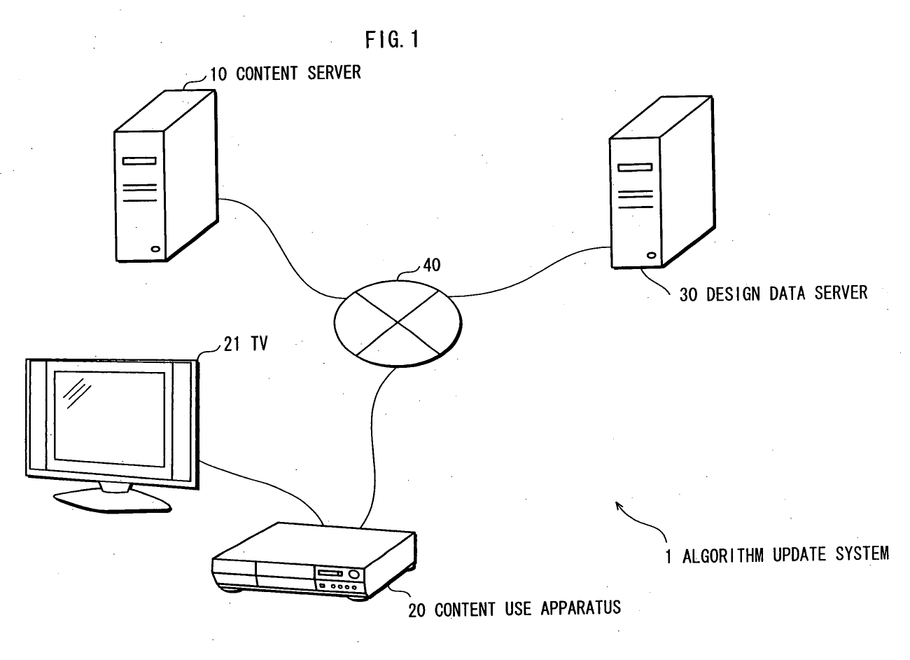

FIG. 1 shows a system structure of the algorithm update system 1. As shown in FIG. 1, the algorithm update system 1 includes a content server 10, a content use apparatus 20, a TV 21, and a design data server 30.

The content use apparatus 20 and the TV 21 are connected with each other via a cable. The content server 10, the content use apparatus 20, and the design data server 30 are connected with each other via a network 40.

### 1. Content Server 10

The content server 10 is a computer system composed of a microprocessor, a ROM, a RAM, a hard disk unit, and so on. A computer program is stored in the RAM or the hard disk unit. Functions of the content server 10 are achieved by the microprocessor executing the computer program.

The content server 10 manages a plurality of encrypted contents using a content table 100 which is described later. Each of the encrypted contents stored in the content server 10 is generated by encrypting a content in accordance with a certain encryption algorithm. Each of the contents in the embodiment data is generated by compression-encoding a movie in accordance with the MPEG-2 standard, for example. Note that the contents in the embodiment are by no means limited to movies. Music, still images, computer programs, and so on may be employed.

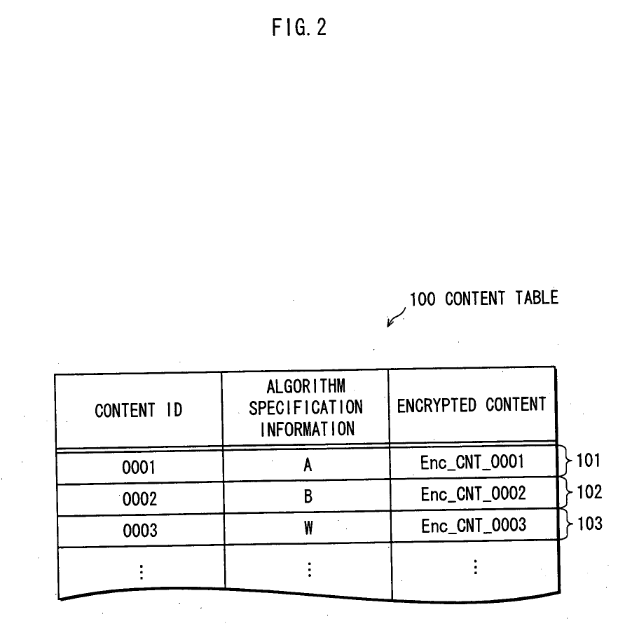

FIG. 2 shows a data structure of the content table 100 stored in the content server 10. As shown in FIG. 2, the content table 100 includes a plurality of pieces of content information 101, 102, 103, and so on. Each piece of the content information includes a content ID, algorithm specification information, and an encrypted content.

For example, the content information 101 includes a content ID “0001”, algorithm specification information “A”, and an encrypted content “Enc_CNT_{—}0001”.

The content ID “0001” is information for uniquely identifying a content and an encrypted content generated by encrypting the content.

The algorithm specification information “A” is information for specifying an algorithm used for generating the encrypted content identified by the content ID “0001”. Here, the algorithm specification information “A” is information showing the DES (Data Encryption Standard), specifically.

The encrypted content “Enc_CNT_{—}0001” is data generated by applying the encryption algorithm specified by the algorithm specification information “A”, i.e., the DES, to a content “CNT_{—}0001” identified by the content ID “0001”, using a content key as an encryption key.

Upon receiving a content transmission request including a content ID from the content use apparatus 20, the content server 10 reads algorithm specification information and an encrypted content respectively corresponding to the received content ID from the content table 100, and transmits the read algorithm specification information and encrypted content to the content use apparatus 20.

Note that each of the encrypted contents stored in the content table 100 is generated using a different content key, and the content key is transmitted to the content use apparatus 20 in a safe and secure manner.

### 2. Content Use Apparatus 20

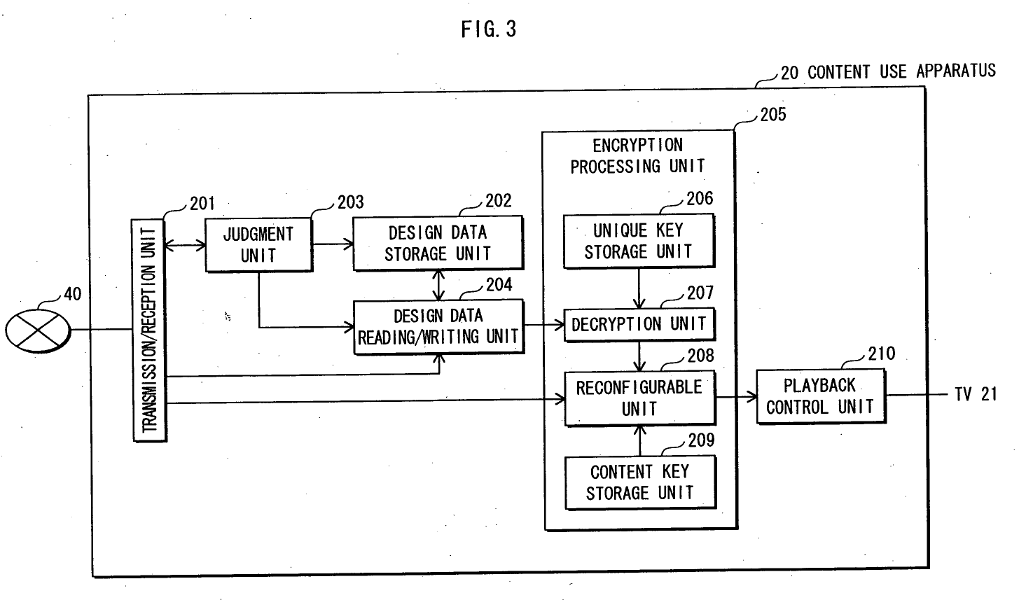

FIG. 3 is a functional block diagram functionally showing a structure of the content use apparatus 20. As shown in FIG. 3, the content use apparatus 20 includes a transmission/reception unit 201, a design data storage unit 202, a judgment unit 203, a design data reading/writing unit 204, an encryption processing unit 205, and a playback control unit 210. Furthermore, the encryption processing unit 205 includes a unique key storage unit 206, a decryption unit 207, a reconfigurable unit 208, and a content key storage unit 209.

The content use apparatus 20 is specifically a computer system composed of a microprocessor, a ROM, a RAM, a hard disk unit, and so on. A computer program is stored in the RAM or the hard disk unit. Functions of the content use apparatus 20 are achieved by the microprocessor executing the computer program. The following describes each of the structural elements of the content use apparatus 20.

### (1) Transmission/Reception Unit 201

The transmission/reception unit 201 is a network connection unit, and transmits/receives data to/from the content server 10 and the design data server 30 via the network 40.

The transmission/reception unit 201 transmits a content transmission request to the content server 10, and receives algorithm specification information and an encrypted content from the content server 10. The transmission/reception unit 201 outputs the received algorithm specification information to the judgment unit 203, and outputs the received encrypted content to the reconfigurable unit 208.

Moreover, the transmission/reception unit 201 transmits a design data transmission request to the design data server 30, and receives encrypted design data from the design data server 30. The transmission/reception unit 201 outputs the received encrypted design data to the design data reading/writing unit 204.

### (2) Design Data Storage Unit 202

The design data storage unit 202 stores encrypted design data generated by encrypting design data. The design data is data necessary for circuit configuration in the reconfigurable unit 208 of the encryption processing unit 205. The design data specifically includes information showing formation and/or logic of logic circuits in the reconfigurable unit 208, information showing wiring of each of the logic circuits, and so on.

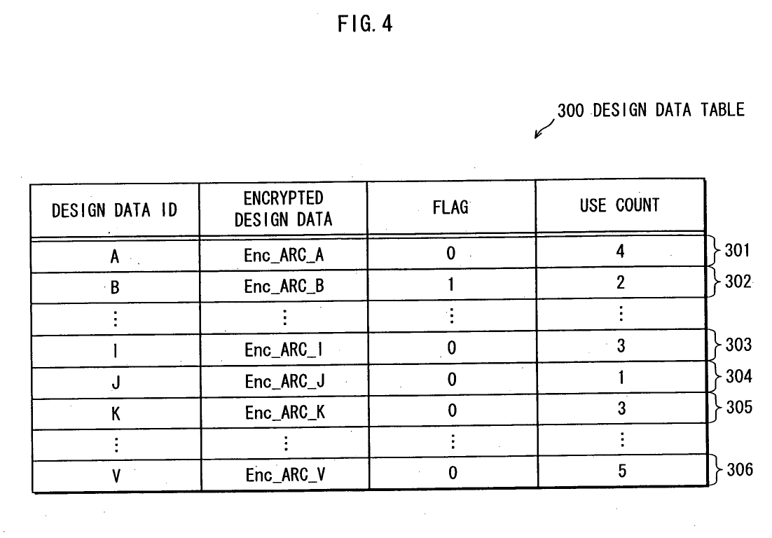

Specifically, the design data storage unit 202 manages design data using a design data table 300, as shown in FIG. 4.

The design data table 300 includes a plurality of pieces of design data information 301, 302, . . . , 303, 304, 305, . . . , 306. Each piece of the design data information includes a design data ID, encrypted design data, a flag, and a use count.

For example, the design data information 301 includes a design data ID “A”, encrypted design data “Enc_ARC_A”, a flag “0”, and a use count “4”.

The design data ID “A” is information for uniquely identifying design data and encrypted design data generated by encrypting the design data. Here, in the embodiment, pieces of design data correspond one-to-one to encryption algorithms. The design data ID “A” is information for identifying design data for configuring a circuit of the encryption algorithm specified by the algorithm specification information “A” in the reconfigurable unit 208. That is, the design data ID “A” is information showing the DES as well as the algorithm specification information “A” described above.

Likewise, a design data ID “B” is information for identifying design data for configuring a circuit of an encryption algorithm specified by algorithm specification information “B”. Likewise, design data IDs “I”, “J”, “K”, and “V” are also pieces of information for identifying pieces of design data for configuring circuits of encryption algorithms specified by pieces of algorithm specification information “I”, “J”, “K”, and “V”, respectively.

The encrypted design data “Enc_ARC_A” is data generated by applying an encryption algorithm E1 to design data “ARC_A” identified by the design data ID “A” using a unique key as an encryption key. One example of the encryption algorithm E1 is the DES.

The flag is set to have either of values “1” and “0”. Design data information including a flag having a value of “1” shows that a current circuit of the reconfigurable unit 208 is configured based on design data identified by a design data ID included in the design data information. Design data information including a flag having a value of “0” shows that a current circuit of the reconfigurable unit 208 is not configured based on design data identified by a design data ID included in the design data information.

A flag included in the design data information 302 has a value of “1”. That is, the design data information 302 shows that a current circuit of the reconfigurable unit 208 is configured based on design data identified by the design data ID “B”. At this time, all the flags included in the other pieces of design data information except the design data information 302 each have a value of “0”.

The use count shows the number of times that a circuit configured based on design data in the reconfigurable unit 208 is used for decrypting encrypted contents.

A use count included in the design data information 301 is “4”. This indicates that the reconfigurable unit 208 configures a circuit based on the design data identified by the design data ID “A”, and decrypts four encrypted contents. Note that, in the embodiment, if a circuit based on the design data identified by the design data ID “A” is configured in the reconfigurable unit 208 and then decryption processing using the circuit is continuously performed a plurality of times, the number of the plurality of times of the decryption processing is counted as a use count of the circuit.

### (3) Judgment Unit 203

The judgment unit 203 functions to perform the following two judgments of (A) and (B).

(A) Upon receiving algorithm specification information from the transmission/reception unit 201, the judgment unit 203 judges whether design data of an encryption algorithm specified by the received algorithm specification information is held in the design data table 300.

Specifically, the judgment unit 203 judges whether a design data ID that matches the received algorithm specification information is stored in the design data table 300. If the matching design data ID exists, the judgment unit 203 judges that the design data is stored in the design data table 300. If the matching design data ID does not exist, the judgment unit 203 judges that the design data is not stored in the design data table 300.

(B) Upon receiving the algorithm specification information from the transmission/reception unit 201, the judgment unit 203 judges whether a circuit is currently configured in the reconfigurable unit 208 based on the design data of the encryption algorithm specified by the received algorithm specification information.

Specifically, the judgment unit 203 reads a value of a flag included in design data information including a design data ID that matches the received algorithm specification information. If the flag has a value of “1”, the judgment unit 203 judges that a circuit is currently configured in the reconfigurable unit 208 based on the design data. If the flag has a value of “0”, the judgment unit 203 judges that a circuit is not currently configured in the reconfigurable unit 208 based on the design data.

If both results in the above judgments (A) and (B) are negative, the judgment unit 203 transmits a design data transmission request including a design data ID to the design data server 30 via the transmission/reception unit 201 and the network 40.

If judging that design data is stored in the design data table 300 and a circuit is not configured, the judgment unit 203 instructs the design data reading/writing unit 204 to configure the circuit based on the design data.

### (4) Design Data Reading/Writing Unit 204

Upon receiving the instruction from the judgment unit 203, the design data reading/writing unit 204 reads the design data from the design data table 300, and outputs the read design data to the decryption unit 207.

Also, if receiving new design data from the design data server 30 via the transmission/reception unit 201 and the network 40, the design data reading/writing unit 204 outputs the received new design data to the decryption unit 207.

Furthermore, the design data reading/writing unit 204 performs design data table update processing. Specifically, the design data reading/writing unit 204 performs update processing of design data information included in a design data table, and performs update processing of the design data table itself. As the update processing of the design data information, the design data reading/writing unit 204 sets a value of a flag and updates a use count, with respect to each piece of the design data information. As the processing of the design data table 300, the design data reading/writing unit 204 generates design data information relating to the new design data received from the design data server 30, and adds the generated design data information to the design data table 300.

Here, addition of design data information is described in detail. The design data reading/writing unit 204 holds a data size threshold value set beforehand based on a maximum storage capacity of the design data storage unit 202. The design data reading/writing unit 204 compares a data size of a design data table currently being stored in the design data storage unit 202 with the data size threshold value. If the data size of the design data table is greater than the data size threshold value, the design data reading/writing unit 204 firstly deletes design data information including the lowest use count from the design data table, and then adds newly generated design data information to the design data table. If the data size of the design data table is no more than the data size threshold value, the design data reading/writing unit 204 adds newly generated design data information to the design data table without deleting any piece of the design data information from the design data table.

Specifically, the following describes update processing in a state where the design data table 300 shown in FIG. 4 is stored in the design data storage unit 202.

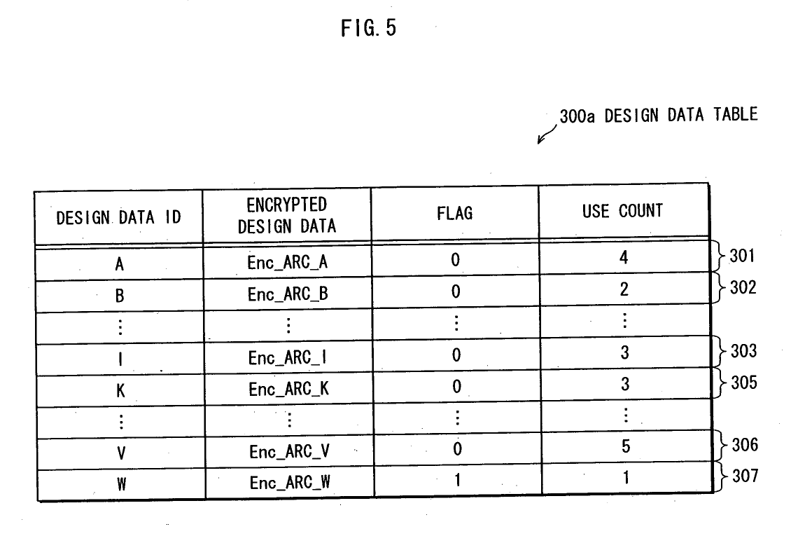

The design data reading/writing unit 204 receives encrypted design data identified by a design data ID “W” from the design data server 30, and generates design data information 307 relating to the encrypted design data. The design data reading/writing unit 204 compares a data size of the design data table 300 with the data size threshold value. If the data size of the design data table 300 is greater than the data size threshold value, the design data reading/writing unit 204 refers to fields of use count in all pieces of the design data information included in the design data table 300, and deletes the design data information 304 including a design data ID “J” relating to a circuit having the lowest use count from the design data table 300. Then, the design data reading/writing unit 2b4 adds the newly generated design data information 307 to the design data table 300 to generate a new design data table 300a shown in FIG. 5.

### (5) Encryption Processing Unit 205

The encryption processing unit 205 includes, as shown in FIG. 3, the unique key storage unit 206, the decryption unit 207, the reconfigurable unit 208, and the content key storage unit 209, and has functions for decrypting encrypted design data, decrypting encrypted contents, and so on.

(a) The unique key storage unit 206 stores a unique key that is key information used for decrypting encrypted design data.

(b) Upon receiving encrypted design data from the design data reading/writing unit 204, the decryption unit 207 reads a unique key from the unique key storage unit 206, and decrypts the received encrypted design data by applying a decryption algorithm D1 to the received encrypted design data using the read unique key as a decryption key. Here, the decryption algorithm D1 is an algorithm for converting cipher texts generated by encrypting plaintexts in accordance with the encryption algorithm E1. The decryption algorithm D1 is the DES, for example. The decryption unit 207 outputs the decrypted design data to the reconfigurable unit 208.

Note that functions of the decryption unit 207 may be realized by either hardware or software.

(c) The reconfigurable unit 208 is specifically composed of a plurality of logical circuit blocks capable of configuring combinational circuits and sequential circuits, and wiring portions between the logical circuit blocks. Each of the logical circuit blocks is a circuit unit including a look-up table and a flip-flop, and configures a desired logical circuit by changing a set value of the look-up table. Also, the wiring portions each have transistor switches and so on arranged therein, and wiring paths can be set freely. Note that, in the embodiment, the reconfigurable unit 208 includes a ROM for storing design data received from the design data reading/writing unit 204.

The reconfigurable unit 208 receives design data from the decryption unit 207, and stores the received design data in the ROM. Based on the design data stored in the ROM, the reconfigurable unit 208 controls the logical circuit blocks and the wiring portions to configure a circuit. In the embodiment, circuits configured in the reconfigurable unit 208 are circuits for decrypting encrypted contents. The reconfigurable unit 208 reads, from the content key storage unit 209, a content key corresponding to an encrypted content received from the transmission/reception unit 201, and decrypts the received encrypted content using the read content key as a decryption key. The reconfigurable unit 208 outputs the decrypted content to the playback control unit 210.

(d) The content key storage unit 209 stores content keys that are decryption keys used for decrypting encrypted contents.

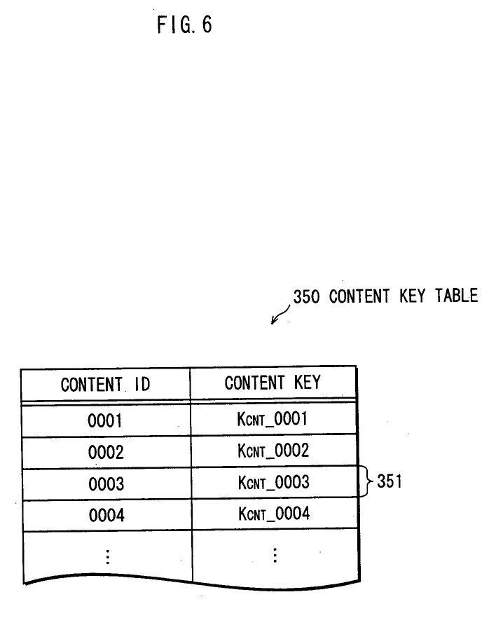

Specifically, the content key storage unit 209 stores a content key table 350 shown in FIG. 6. The content key table 350 includes a plurality of pieces of content key information. Each piece of the content key information is composed of a content ID and a piece of data of a content key in correspondence with each other. For example, content key information 351 is composed of a content ID “0003” and a content key “KCNT_{—}0003”. This indicates that a content key for decrypting an encrypted content identified by the content ID “0003” is the content key “KCNT_{—}0003”.

The content key table 350 is transmitted to the content use apparatus 20 from the content server 10 in a safe and secure manner. Note that, in the embodiment, the content use apparatus 20 is not necessarily structured to have a plurality of content keys beforehand as described above. Instead of this, the content use apparatus 20 may receive a content key together with an encrypted content from the content server 10 each time receiving an encrypted content.

### (6) Playback Control Unit 210

The playback control unit 210 receives a decrypted content from the reconfigurable unit 208, and converts the received content into playable information. Specifically, the playback control unit 210 is composed of a video buffer, an audio buffer, an MPEG-2 video decoder, an MPEG-2 audio decoder, and so on, and, generates a video signal and a sound signal from the received content. The playback control unit 210 outputs the generated video and sound signals to the TV 21.

### 3. Design Data Server 30

The design data server 30 is a computer system composed of a microprocessor, a ROM, a RAM, a hard disk unit, and soon. A computer program is stored in the RAM or the hard disk unit. Functions of the design data server 30 are achieved by the microprocessor executing the computer program.

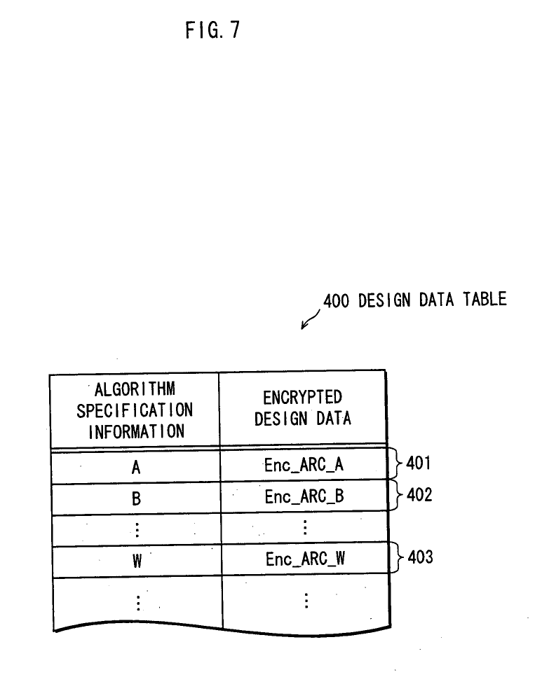

The design data server 30 manages a plurality of pieces of encrypted design data using a design data table 400 shown in FIG. 7.

The design data table 400 includes, as shown in FIG. 7, a plurality of pieces of design data information 401, 402, . . . , 403, Each piece of the design data information is composed of algorithm specification information and encrypted design data in correspondence with each other.

The encrypted design data is encrypted data generated by applying the encryption algorithm E1 to design data using a unique key as key information. For example, the encrypted design data “Enc_ARC_A” included in the design data information 401 is data generated by encrypting the design data “ARC_A”. Encrypted design data “Enc_ARC_W” included in the design data information 403 is data generated by encrypting design data “ARC_W”. As described above, design data in the embodiment is data needed to configure a decryption circuit for decrypting encrypted contents in the reconfigurable unit 208 of the content use apparatus 20.

Each piece of the algorithm specification information shows an algorithm realized by a circuit configured in the reconfigurable unit 208 based on a corresponding piece of design data. Specifically, the algorithm specification information “A” included in the design data information 401 is information for specifying an algorithm of the circuit configured based on the design data “ARC_A”. Here, if the algorithm specification information “A” is information showing the DES as a specific example, the design data “ARC_A” is data necessary for configuring a decryption circuit of the DES in the reconfigurable unit 208 of the content use apparatus 20.

Upon receiving a design data transmission request including algorithm specification information from the content use apparatus 20, the design data server 30 reads encrypted design data corresponding to the received algorithm specification information from the design data table 400, and transmits the read encrypted design data to the content use apparatus 20.

For example, if receiving a design data transmission request including algorithm specification information “W” from the content use apparatus 20, the design data server 30 reads the design information 403 from the design data table 400, further reads the encrypted design data “Enc_ARC_W” from the design information 403, and transmits' the read encrypted design data “Enc_ARC_W” to the content use apparatus 20.

Note that each piece of the encrypted design data stored in the design data table 400 is encrypted using the same unique key, and the unique key used for encryption is transmitted to the content use apparatus 20 in a safe and secure manner.

### <Operations>

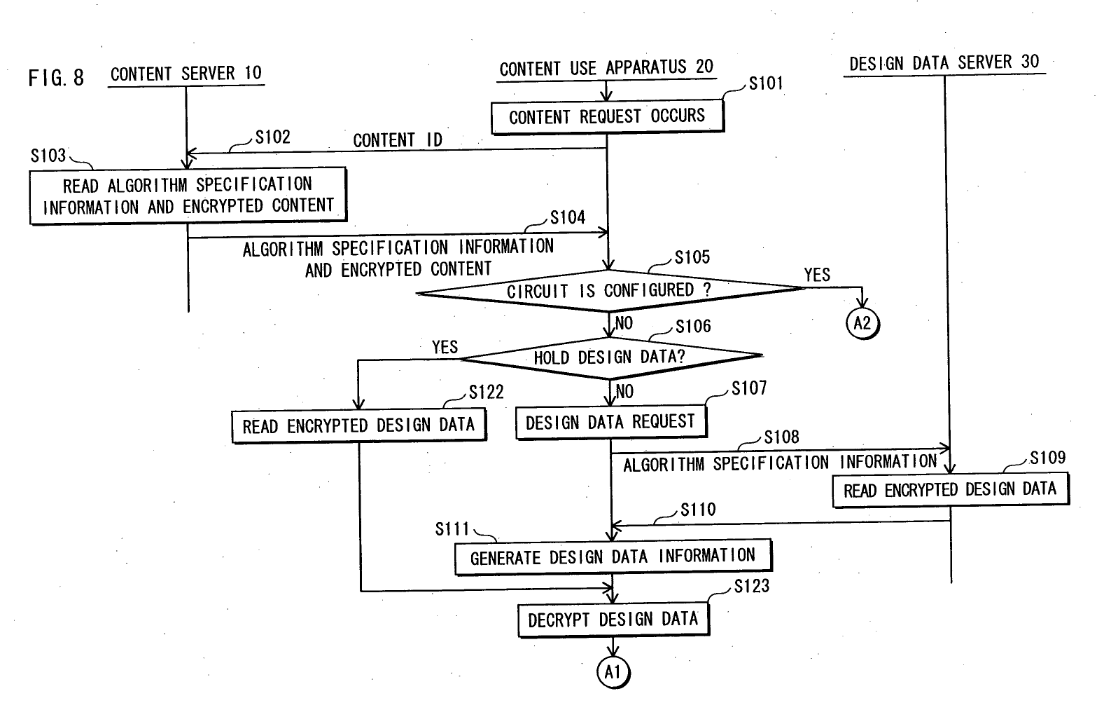

Here, operations of the algorithm update system 1 are described using flow charts shown in FIG. 8 to FIG. 10.

### 1. Overall Operation of System

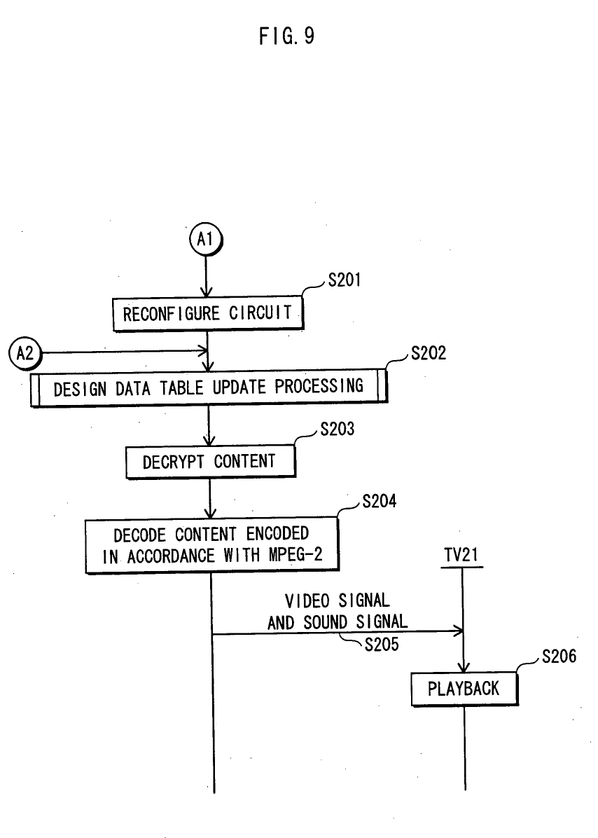

FIG. 8 and FIG. 9 are flow charts each showing the overall operation of the algorithm update system 1.

First, a content request occurs in the content use apparatus 20 (Step S101). The content request occurs, for example, by a user inputting a content ID of a content the user has viewed to the content use apparatus 20 using an input unit, which is not illustrated.

The transmission/reception unit 201 of the content use apparatus 20 transmits a content transmission request including the content ID to the content server 10 via the network 40. The content server 10 receives the content transmission request (Step S102).

The content server 10 reads, from the content table 100, content information including a content ID that matches the content ID included in the received content transmission request. Next, the content server 10 reads algorithm specification information and an encrypted content from the read content information (Step S103). For example, if receiving a content transmission request including the content ID “0003” in Step S102, the content server 10 reads the content information 103 from the content table 100, and further reads the algorithm specification information “W” and an encrypted content “Enc_CNT_{—}0003” from the read content information 103.

The content server 10 transmits the read algorithm specification information and encrypted content to the content use apparatus 20. The transmission/reception unit 201 of the content use apparatus 20 receives the algorithm specification information and the encrypted content via the network 40 (Step S104). The transmission/reception unit 201 outputs the received encrypted content to the reconfigurable unit 208 together with a content ID of the encrypted content, and outputs the received algorithm specification information to the judgment unit 203.

Next, the judgment unit 203 judges whether a circuit of an encryption algorithm specified by the algorithm specification information received in Step S104 is currently configured in the reconfigurable unit 208 (Step S105).

Specifically, the judgment unit 203 reads fields of flag of a plurality of pieces of design data information included in a design data table to read a design data ID of a piece of the design data corresponding to a flag having a value of “1”. The judgment unit 203 judges whether the design data ID read from the design data table matches the algorithm specification information received in Step S104.

If the design data ID matches the algorithm specification information, the judgment unit 203 judges that a desired circuit is currently configured in the reconfigurable unit 208. If the design data ID does not match the algorithm specification information, or if the design data ID cannot be read from the design data table, the judgment unit 203 judges that a desired circuit is not currently configured in the reconfigurable unit 208.

As a specific example, if the algorithm specification information received in Step S104 is “A” and the design data storage unit 202 stores the design data table 300 shown in FIG. 4, design data information including a f lag having a value of “1” is the design data information 302 including the design data ID “B”. Therefore, the design data ID “B” does not match the design data ID “A”. The judgment unit 203 judges that a circuit based on the design data is not currently configured in the reconfigurable unit 208. On the other hand, if the algorithm specification information received in Step S104 is “B”, the judgment unit 203 judges that a circuit based on the design data is currently configured in the reconfigurable unit 208.

In Step S105, if the circuit is configured in the reconfigurable unit 208 (Step S105: YES), the flow proceeds to Step S202 to perform the subsequent processing.

In Step S105, if the circuit is not configured in the reconfigurable unit 208 (Step S105: NO), the judgment unit 203 judges whether the design data of the algorithm specified by the algorithm specification information received in Step S104 is held in the design data storage unit 202 (Step S106). Specifically, the judgment unit 203 performs this judgment by judging whether a design data ID that matches the algorithm specification information received in Step S104 exists in the design data table.

As a specific example, the following case is described. Assume that the design data storage unit 202 stores the design data table 300 shown in FIG. 4, and the judgment unit 203 receives the algorithm specification information “W”. The judgment unit 203 reads fields of design data ID of all pieces of the design data information included in the design data table 300 to judge whether a design data ID that matches the algorithm specification information “W” exists. If the design data ID “W” exists, the judgment unit 203 judges that the design data is stored in the design data table 300. If the design data ID “W” does not exist, the judgment unit 203 judges that the design data is not stored in the design data table 300.

In Step S106, if the design data of the algorithm specified by the algorithm specification information received in Step S104 is held (Step S106: YES), the design data reading/writing unit 204 reads encrypted design data from the design data storage unit 202 (Step S122), and outputs the read encrypted design data to the decryption unit 207. Then, the flow proceeds to Step S123 to perform the subsequent processing.

In Step S106, if the design data of the algorithm specified by the algorithm specification information received in Step S104 is not held (Step S106: NO), the judgment unit 203 generates a design data request including the algorithm specification information received in Step S104 (Step S107). The judgment unit 203 transmits the design data request including the algorithm specification information to the design data server 30 via the transmission/reception unit 201 and the network 40. The design data server 30 receives the design data request (Step S108).

The design data server 30 reads, from the design data table 400, design data information including algorithm specification information that matches the algorithm specification information included in the design data request received in Step S108. Next, the design data server 30 reads encrypted design data from the read design data information (Step S109). Here specifically, if receiving the algorithm specification information “W” in Step S108, the design data server 30 reads the design data information 403 including the algorithm specification information “W” from the design data table 400 shown in FIG. 7, and then reads the encrypted design data “Enc_ARC_W” from the design data information 403.

The design data server 30 transmits the read encrypted design data to the content use apparatus 20 via the network 40. The transmission/reception unit 201 of the content use apparatus 20 receives the encrypted design data (Step S110). The transmission/reception unit 201 outputs the received encrypted design data to the design data reading/writing unit 204.

Next, the design data reading/writing unit 204 generates design data information relating to the encrypted design data received in Step S110 (Step S111). Specifically, the design data reading/writing unit 204 generates a piece of information including a design data ID, encrypted design data, a flag, and a use count. Then, the flow proceeds to Step S123. Here, the design data reading/writing unit 204 writes the algorithm specification information received in Step S104 into a field of design data ID, and writes the encrypted design data received in Step S110 into a field of encrypted design data. Also, at this time, the design data reading/writing unit 204 sets the flag to have a value of “0”, and writes a value of “0” into a field of use count.

Next, the design data reading/writing unit 204 outputs the encrypted design data to the decryption unit 207.

Upon receiving the encrypted design data from the design data reading/writing unit 204, the decryption unit 207 reads a unique key from the unique key storage unit 206. The decryption unit 207 decrypts the encrypted design data by applying the decryption algorithm D1 to the encrypted design data using the read unique key as a decryption key (Step S123). The decryption unit 207 outputs the decrypted design data to the reconfigurable unit 208.

Then, the reconfigurable unit 208 configures a circuit based on the design data received from the decryption unit 207 (Step S201).

Next, the design data reading/writing unit 204 performs update processing of the design data table (Step S202).

Next, the reconfigurable unit 208 reads, from the content key table 350 of the content key storage unit 209, a content key corresponding to the content ID received from the transmission/reception unit 201. Specifically, if receiving the content ID “0003”, the reconfigurable unit 208 reads the content key “KCNT_{—}0003” from the content key information 351 included in the content key table 350.

The reconfigurable unit 208 decrypts the encrypted content using the read content key as a decryption key (Step S203). The reconfigurable unit 208 outputs the decrypted content to the playback control unit 210.

Then, the playback control unit 210 decodes the content that has been compression-encoded in accordance with MPEG-2 specification (Step S204) to generate a video signal and a sound signal. The playback control unit 210 outputs the generated video and sound signals to the TV 21 (Step S205), and the TV 21 plays back the received video and sound signals (Step S206).

Note that the processing in Steps S202, 203, and 204 do not necessarily need to be performed in the stated order. Instead, the processing in theses Steps may be performed in parallel.

### 2. Operations of Design Data Table Update Processing

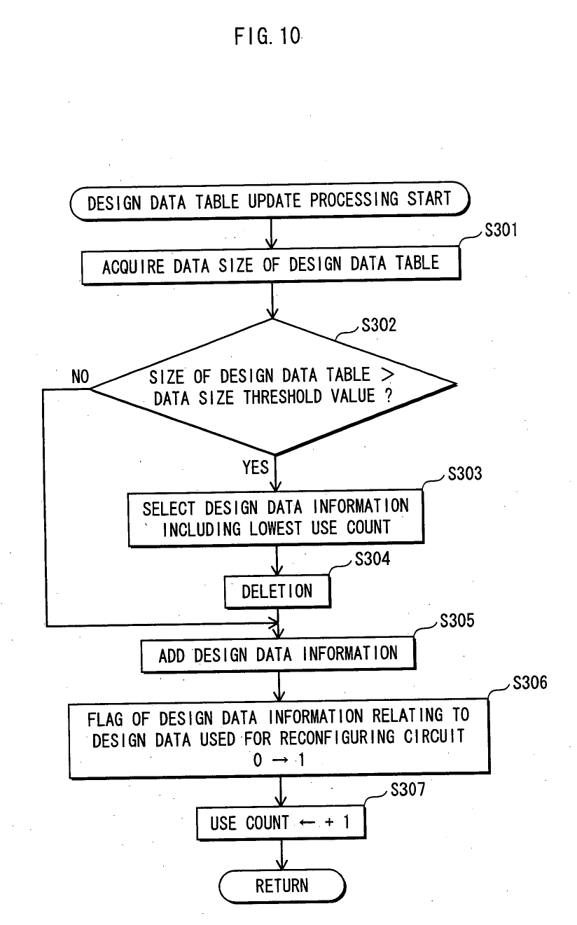

FIG. 10 is a flow chart showing operations of design data table update processing. Note that the operations shown in FIG. 10 describes in detail Step S202 shown in FIG. 9.

The design data reading/writing unit 204 acquires a data size of the design data table stored in the design data storage unit 202 (Step S301). Next, the design data reading/writing unit 204 compares the data size acquired in Step S301 with the data size threshold value stored therein beforehand. If the data size of the design data table is no more than the data size threshold value (Step S302: NO), the flow proceeds to Step S305. If the data size of the design data table is greater than the data size threshold value (Step S302: YES), the design data reading/writing unit 204 reads fields of use counts of all pieces of the design data information included in the design data table to select a piece of design data information including the lowest use count (Step S303).

The design data reading/writing unit 204 deletes the piece of design data information selected in Step S303 from the design data table (Step S304).

Next, the design data reading/writing unit 204 additionally writes the design data information generated in Step S110 of FIG. 8 into the design data table (Step S305).

Then, the design data reading/writing unit 204 sets a flag of design data information relating to design data currently being used for configuring a circuit is to have a value of “1” (Step S306), and sets flags of other pieces of the design data information to each have a value of “0”. Next, the design data reading/writing unit 204 increments by one a use count included in the design data information relating to the design data used for configuring the circuit (Step S307), and ends the processing.

### <Modifications>

While the present invention has been described based on the above embodiment, the present invention is not limited to the above embodiment. The following cases are also included in the present invention.

(1) The above embodiment has a structure such that each piece of design data information has provided therein a field showing a use count to manage a count that design data included in the piece of design data information is used for content decryption processing in the reconfigurable unit 208. A piece of design data information including the lowest use count is preferentially deleted. However, each piece of the design data information in the present invention may not have provided therein a field showing a use count.

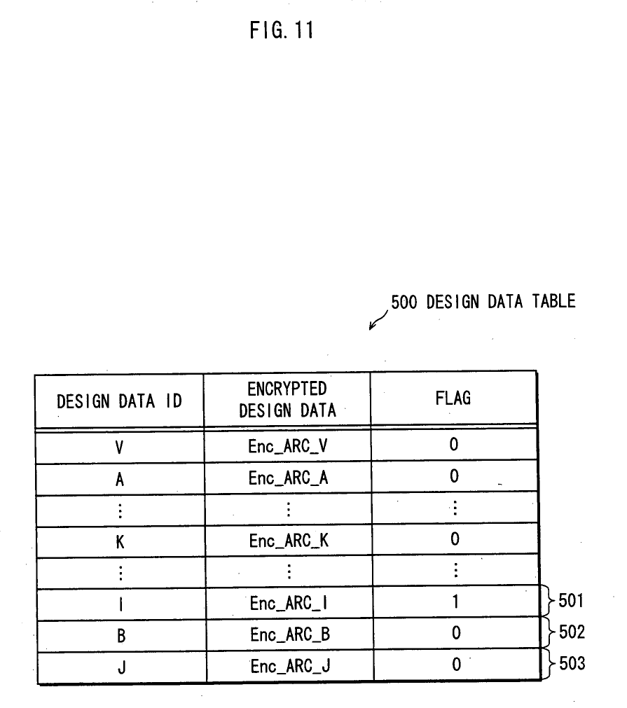

For example, the design data storage unit 202 may store a design data table 500 shown in FIG. 11. The design data table 500 includes a plurality of pieces of design data information, each piece of which includes a design data ID, encrypted design data, and a flag. The design data table 500 differs from the design data table 300 shown in FIG. 4 in that each piece of the design data information does not include a field of use count.

In a case where the design data storage unit 202 stores such a design data table in which each piece of the design data information that does not include a use count, the design data reading/writing unit 204 may be structured as follow. If a piece of design data is used for decrypting an encrypted content, the design data reading/writing unit 204 moves, in the design data table 500, a recording position of a piece of design data information including the used piece of the design data one row up.

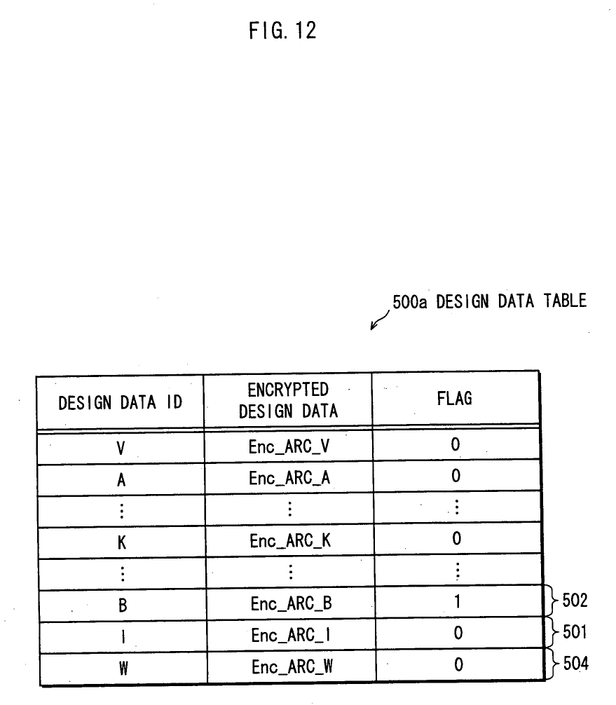

For example, if design data identified by the design data ID “B” is used for decrypting an encrypted content, the design data reading/writing unit 204 moves, in the design data table 500, a recording position of design data information 502 one row up. As a result, the design data information 502 is arranged one row up above design data information 501 including a design data ID “I”, as shown in a design data table 500a shown in FIG. 12.

Each time decryption processing of contents is performed in the reconfigurable unit 208, the design data reading/writing unit 204 rearranges pieces of the design data information. Due to this rearrangement, the design data table has a structure in which a piece of design data information including the highest use count is arranged on the top row, and other pieces of the design data information are arranged in descending order of use count from top to bottom.

If deleting any piece of the design data information from the design data table, the design data reading/writing unit 204 can preferentially delete a piece of design data information in descending order of use count in the same way as in the above embodiment by preferentially deleting a piece of the design data information from bottom to top in the design data table.

Also, as a modification of the rearrangement of pieces of the design data information, a piece of design data information used for decryption processing of a content in the reconfigurable unit 208 maybe arranged on the top row in the design data table. According to this structure, a piece of design data that has been recently used can be prevented from being deleted.

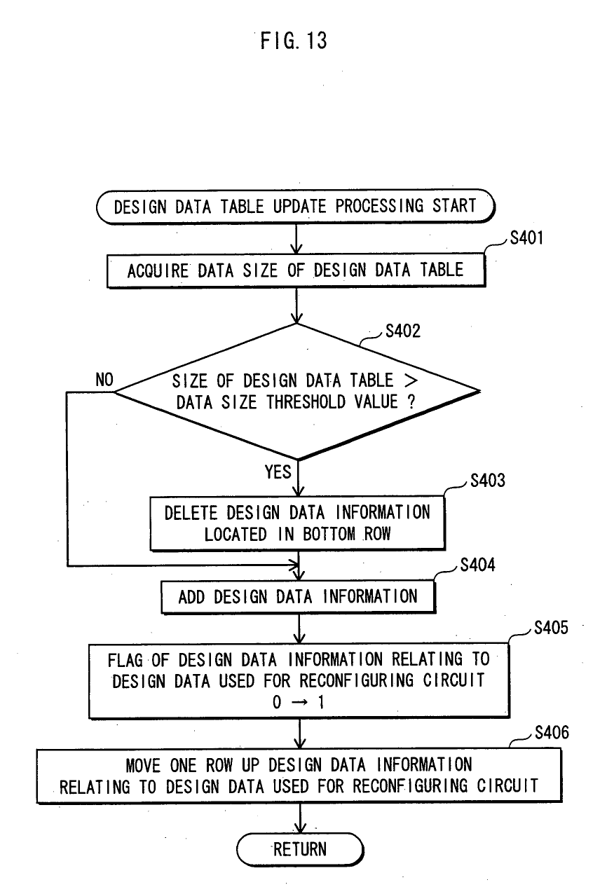

FIG. 13 is a flow chart showing operations of processing for rearranging pieces of design data information to update a design data table. Note that the operations described here correspond to the details of Step S202 shown in FIG. 9 in the whole system.

The design data reading/writing unit 204 acquires the data size of the design data table stored in the design data storage unit 202 (Step S401). Next, the design data reading/writing unit 204 compares the data size acquired in Step S401 with the data size threshold value stored therein beforehand. If the acquired data size of the design data table is no more than the data size threshold value (Step S402: NO), the flow proceeds to Step S404. If the acquired data size of the design data table is greater than the data size threshold value (Step S402: YES), the design data reading/writing unit 204 deletes a piece of the design data information that is positioned in the bottom row in the design data table (Step S403).

Next, the design data reading/writing unit 204 additionally writes the piece of design data information generated in Step S110 of FIG. 8 into the design data table (Step S404).

Then, the design data reading/writing unit 204 sets a flag of design data information relating to design data currently being used for configuring a circuit is to have a value of “1” (Step S405), and sets flags of other pieces of the design data information to each have a value of “0”.

Next, the design data reading/writing unit 204 moves, in the design data table, one row up a recording position of the piece of the design data information relating to the piece of the design data currently being used for configuring a circuit in the reconfigurable unit 208 (Step S406), and ends the processing.

Note that although the piece of the design data information that is positioned in the bottom row is deleted in Step S403, a predetermined number of pieces of the design data information may be deleted at a time when deleting any piece of the design data information. For example, the number of pieces of the design data information to be deleted may be determined in accordance with the data size of the design data table. Also, this structure may be employed in the embodiment in which each piece of the design data information includes a field of use count.

(2) Design data in the present invention may be structured such that a storage location thereof changes in accordance with a use count thereof.

For example, the content use apparatus in the present invention may be structured to include, as storage locations of design data, an EEPROM having a higher reading speed and an HDD having a lower reading speed. Apiece of design data information including a higher use count may be stored in the EEPROM having a higher reading speed, and a piece of design data information including a lower use count may be stored in the HDD.

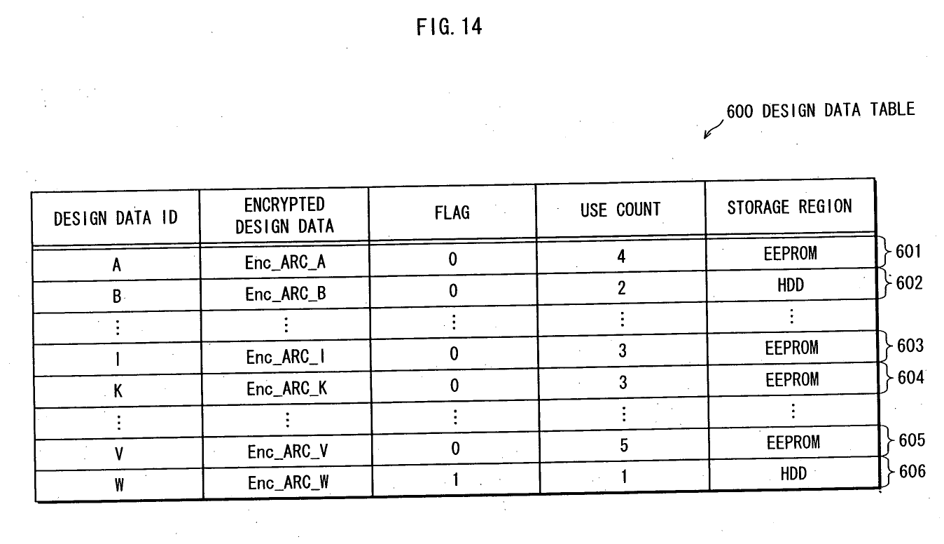

FIG. 14 shows a data structure of a design data table 600 stored in a design data storage unit of a content use apparatus having the above described structure. As shown in FIG. 14 the design data table 600 includes a plurality of pieces of design data information 601, 602, . . . , 603, 604, . . . , 605, and 606.

Each piece of the design data information includes a design data ID, encrypted design data, a flag, a use count, and a storage location. The design data table 600 differs from the design data tables of the above embodiment in that the design data table 600 includes a field of storage location. For example, in the design data table 600, if a use count of a piece of design data is either “1” or “2”, the piece of the design data is stored in the HDD. If a use count of a piece of design data is no less than “3”, the piece of the design data is stored in the EEPROM.

Furthermore, the design data reading/writing unit may be structured to change a storage location of design data in accordance with a use count thereof. According to this structure, a piece of the design data having a higher possibility of being used in the future can be stored in the EEPROM having a higher reading speed, and a piece of the design data having a lower possibility of being used can be stored in the HDD having a lower reading speed.

(3) The encryption processing unit 205 in the above embodiment has a structure to perform decryption processing of encrypted design data and decryption processing of encrypted contents. However, the content use apparatus of the present invention is not limited to the cases of the decryption processing, and includes cases of encryption processing.

Furthermore, the present invention is not limited to the content use apparatus that performs encryption processing/decrypt processing, and is also applicable to cases of encoding processing/decoding processing of contents. In this case, the content use apparatus holds therein a plurality of pieces of design data for configuring a circuit respectively corresponding to a plurality of encoding algorithms. If the content use apparatus holds therein a piece of the design data corresponding to a requested one of the encoding algorithms, the circuit may be configured in the reconfigurable unit based on the held piece of the design data. If the content use apparatus does not hold therein a piece of the design data corresponding to a requested one of the encoding algorithms, a desired design data is acquired from an external design data server, and a circuit may be configured in the reconfigurable unit based on the acquired design data.

(4) The above embodiment has a structure such that the content use apparatus 20 and the design data server 30 are connected with each other via the network 40. The content use apparatus 20 is structured to acquire design data from the design data server 30 through communication via the network 40. However, in the present invention, the content use apparatus 20 is not necessarily structured to acquire design data via a network. For example, the present invention includes the following structure. The content use apparatus 20 includes a medium input/output unit that inputs/outputs information to/from a recording medium. The content use apparatus 20 directly accesses the recording medium having design data stored therein to acquire the design data from the recording medium.

Furthermore, the above embodiment has a structure such that the content use apparatus 20 and the content server 10 are connected with each other via the network 40. The content use apparatus 20 is structured to acquire algorithm specification information and encrypted contents from the content server 10 through communication via the network 40. However, in the present invention, the content use apparatus 20 is not necessarily structured to acquire algorithm specification information and encrypted contents via a network. The present invention also includes the content use apparatus 20 having a structure to include the medium input/output unit as described above, and acquire algorithm specification information and encrypted contents from the recording medium via the medium input/output unit.

Furthermore, the content use apparatus 20 may be structured to acquire either algorithm specification information or encrypted contents via the network 40, and acquire the other remaining of the algorithm specification information and the encrypted contents from the recording medium.

(5) The above embodiment has a structure such that each of a plurality of content keys held in the content key storage unit 209 is different for each content. However, this structure in which content keys are different for each content is not essential in the present invention.

Also, the above embodiment has a structure such that unique keys held in the unique key storage unit 206 each are different data held in the content key storage unit 209. However, the present invention is not limited to this structure. For example, the unique key may be the same as the content keys. Furthermore, content keys may not be static key data, and may be dynamically calculated and temporally stored in the content key storage unit 209. Likewise, unique keys for decrypting encrypted design data are not necessarily specific to the content use apparatus 20. The unique key may be a key shared by a plurality of apparatuses, and furthermore may have a structure such that key data is changed or updated.

(6) The above embodiment has a structure such that if not holding design data of an algorithm specified by algorithm specification information, the content use apparatus 20 acquires the design data via the network 40. However, the present invention is not limited to this structure. For example, the content use apparatus 20 may be structured to include a notification unit, and notify the user that the content use apparatus 20 does not hold the design data. The content use apparatus 20 may receive a command from the user to acquire the design data.

(7) The above embodiment has a structure such that a design data table held in the design data storage unit 202 stores design data for configuring a circuit in there configurable unit 208. However, the present invention is not limited to this structure. For example, encryption algorithms realized in the decryption unit 207 may be managed using the same design data table. Functions of the decryption unit 207 may be used for decryption processing of encrypted contents.

According to this structure, if an encryption algorithm realized in the decryption unit 207 is the DES and an algorithm of a decryption circuit needed for decrypting an encrypted content is the DES, a decryption circuit of the DES does not need to be newly configured in the reconfigurable unit 208, and the encrypted content can be decrypted in the decryption unit 207.

(8) The above embodiment has a structure such that an algorithm for decrypting an encrypted content is specified based on algorithm specification information received from the content server 10. However, the present invention is not limited to this structure.

For example, if the content use apparatus 20 acquires an encrypted content from a plurality of supply sources, an encryption algorithm to be used may be predetermined in accordance with an acquisition source of the encrypted content (a supply source of the encrypted content).

(9) The above embodiment has a structure such that if updating a design data table, design data information is deleted in accordance with a use count included in the design data information. However, the present invention is not limited to this structure. For example, if apiece of design data needs to be deleted because of an insufficient capacity of the design data storage unit 202, one or more pieces of design data most efficient to resolve the insufficient capacity may be deleted. Specifically, if a piece of design data of 30 KB is added, a piece of design data of 10 KB and a piece of design data of 20 KB may be deleted instead of deleting a piece of design data of 100 KB.

(10) The above embodiment has a structure such that if a design data table is updated, a piece of design data positioned in the bottom row in the design data table is deleted. However, the present invention is not limited to this structure. For example, the design data table is periodically referred to, and a predetermined number. of pieces of design data information are deleted in order from bottom to top.

(11) The above embodiment has a structure such that if the capacity of the design data storage unit 202 becomes insufficient (specifically, if the data size of the design data table is greater than the data size threshold value), the design data reading/writing unit 204 deletes design data. However, the present invention is not limited to this structure. For example, if the design data functions to realize encryption processing and the security of the encryption algorithm lowers, the design data reading/writing unit 204 may delete the design data in accordance with an external instruction. In this case, if a circuit is configured in the reconfigurable unit 208 based on the design data, the design data reading/writing unit 204 may delete the circuit together with the design data. Also, in accordance with an external deletion instruction in addition to the security lowering, the design data reading/writing unit 204 may delete the design data or the circuit of the reconfigurable unit 208.

(12) In the above embodiment, the case is described where the number of pieces of design data used for configuring a circuit in the reconfigurable unit 208 is one. However, this structure is not essential in the present invention, and a case is also included in the present invention where a circuit is configured based on no less than two pieces of design data. Specifically, if a circuit is configured in the reconfigurable unit 208 based on pieces of design data identified by the design data IDs “B” and “K”, a value of “1” is written into fields of flag of the pieces of design data information including the design data IDs “B” and “K”. A value of “0” may be written into fields of flag of other pieces of design data information.

(13) As an example of a “use frequency” described in Claims, a use count is employed in the above embodiment in which a circuit configured in the reconfigurable unit 208 based on design data is used for decryption processing of encrypted contents. However, the present invention is not limited to this structure.

As other example, a loading count that shows the number of times that design data is loaded into the reconfigurable unit 208 may be employed. Specifically, each piece of the design data information that constitutes the design data table 300 may include a loading count instead of a use count. Each time reading encrypted design data from the design data storage unit 202, the design data reading/writing unit 204 increments by one a use count corresponding to the read encrypted design data.

(14) The present invention may be the above methods. Also, the present invention may be a computer program that realizes the methods by a computer, or a digital signal composed of the computer program.

Furthermore, the present invention may be a computer-readable recording medium such as a flexible disk, a hard disk, a CD-ROM, an MO, a DVD, a DVD-ROM, a DVD-RAM, a BD, and a semiconductor memory, which stores the computer program or the digital signal. Furthermore, the present invention may be the computer program or the digital signal stored in the recording medium.

Furthermore, the present invention may be the computer program or the digital signal transmitted via an electric communication network, a wireless or wired communication line, a network such as Internet, data broadcasting, and the like.

Furthermore, the present invention may be a computer system that includes a microprocessor and a memory, the memory storing the computer program, and the microprocessor operating in accordance with the computer program.

Furthermore, the program or the digital signal may be executed by other independent computer system, by transferring the program or the digital signal to the recording medium, or by transferring the program or the digital signal via the network or the like.

(15) Furthermore, functional blocks of the content server 10, the content use apparatus 20, and the design data server 30 in the above embodiment may be partially or entirely realized by an LSI that is an integrated circuit. These may be individually realized in one chip, or partially or entirely contained in one chip. The LSI mentioned here can also be called an IC, a system LSI, a super LSI, or an ultra LSI depending on the degree of integration.

Furthermore, the integration is not limited to the above LSI, and may be performed using a dedicated circuit. An FPGA (Field Programmable Gate Array) that can be programmed or a reconfigurable processor capable of reconfiguring connections and settings of circuit cells in an LSI after producing the LSI may be used.

Furthermore, if an integrated circuit technique that replaces an LSI emerges from advancement of semiconductor technology or other derivative technology, such a technique can be used for the integration of the functional blocks. One possibility lies in adaptation of biotechnology.

(16) The present invention includes any combination of the above embodiment and modifications.

### INDUSTRIAL APPLICABILITY

The present invention is applicable commercially, continuously, and repeatedly in the industry that provides users with contents and the industry that manufactures and sells apparatuses capable of using the contents.

1. A content use apparatus comprising:
a reconfigurable unit operable to configure a circuit based on a piece of design data;
a first judgment unit operable to judge whether a content use circuit has been configured in the reconfigurable unit, the content use circuit realizing a function relating to use of a content;
a second judgment unit operable to judge whether content use design data for configuring the content use circuit has been stored; and
an acquisition unit operable, if the first judgment unit and the second judgment unit judge negatively, to acquire the content use design data from outside, wherein
the reconfigurable unit configures the content use circuit based on the acquired content use design data.

2. The content use apparatus of claim 1 further comprising
a design data storage unit operable to store pieces of the design data for configuring circuits that realize functions relating to use of the content, wherein
the second judgment unit performs the judgment by judging whether the content use design data has been stored in the design data storage unit.

3. The content use apparatus of claim 2, wherein
the functions include encryption of the content and decryption of an encrypted content generated by encrypting the content, and
the content use circuit realizes the encryption and the decryption.

4. The content use apparatus of claim 2 being connected with an external design data server via a network, wherein
the acquisition unit acquires the content use design data from the design data server.

5. The content use apparatus of claim 4 being connected with an external content server via a network, and receiving, from the content server, a design data identifier for uniquely identifying the content and the content use design data, wherein
the acquisition unit outputs the design data identifier to request the design data server to transmit the content use design data, and
the reconfigurable unit configures, based on the acquired content use design data, the content use circuit that realizes decryption of an encrypted content generated by encrypting the content.

6. The content use apparatus of claim 3 further comprising
a medium input unit operable to read information from a recording medium, wherein
the acquisition unit acquires the content use design data stored in the recording medium via the medium input unit.

7. The content use apparatus of claim 2, wherein
the functions include encoding of the content and decoding of an encoded content generated by encoding the content, and
the content use circuit realizes the encoding or the decoding.

8. The content use apparatus of claim 2, wherein
the design data storage unit stores a design data table having the pieces of the design data arranged therein,
if acquiring the content use design data, the acquisition unit writes the acquired content use design data into the design data table,
the content use apparatus further comprises:
a deletion judgment unit operable to judge whether to delete any piece of the design data based on a data size of the design data table; and
a design data deletion unit operable, if the deletion judgment unit judges affirmatively, to select a piece of the design data to be deleted, and delete the selected piece of the design data.

9. The content use apparatus of claim 8, wherein
the design data table stores pieces of design data use information in one-to-one correspondence to the pieces of the design data, each of the pieces of the design data use information showing a use frequency that a corresponding piece of the design data is used for circuit configuration, and
if the deletion judgment unit judges affirmatively, the design data deletion unit selects, as the piece of the design data to be deleted, a piece of the design data corresponding to a piece of the design data use information showing the lowest use frequency, by reading the pieces of the design data use information.

10. The content use apparatus of claim 8, wherein
if the deletion judgment unit judges affirmatively, the design data deletion unit preferentially selects, as the piece of the design data to be deleted, a piece of the design data corresponding to a piece of the design data use information showing a use frequency no less than a predetermined value, by reading the pieces of the design data use information.

11. The content use apparatus of claim 2, wherein
the design data storage unit stores a design data table having the pieces of the design data arranged therein,
if acquiring the content use design data, the acquisition unit writes the acquired content use design data into the design data table,
the content use apparatus further comprises:
an update unit operable, if the content use circuit is configured in the reconfigurable unit, to rearrange the pieces of the design data included in the design data table.

12. The content use apparatus of claim 11 further comprising:
the content use apparatus further comprises:
a deletion judgment unit operable to judge whether to delete any piece of the design data based on a data size of the design data table; and
a design data deletion unit operable, if the deletion judgment unit judges affirmatively, to delete a predetermined number of the pieces of the design data from the design data table in ascending order of priority.

13. The content use apparatus of claim 12, wherein
when a piece of the design data is used for configuring the content use circuit, the update unit elevates, one level up in the design data table, a priority of the piece of the design data.

14. The content use apparatus of claim 12, wherein
when a piece of the design data is used for configuring the content use circuit, the update unit gives a highest priority in the design data table to the piece of the design data.

15. The content use apparatus of claim 2, wherein
the design data storage unit comprising:
a first storage unit operable to read the pieces of the design data at a first access speed; and
a second storage unit operable to read the pieces of the design data at a second access speed higher than the first access speed, wherein
the design data storage unit stores, in the first storage unit, a piece of the design data having a use frequency of circuit configuration in the reconfigurable unit that is no less than a predetermined value, and stores, in the second storage unit, a piece of the design data having the use frequency that is less than the predetermined value.

16. The content use apparatus of claim 15, wherein
the design data storage unit further stores a design data table including the pieces of the design data in one-to-one correspondence to use frequencies thereof and storage locations thereof, and
moves each of the pieces of the design data, in accordance with a corresponding use frequency, to a corresponding storage location between the first storage unit and the second storage unit.

17. The content use apparatus of claim 2, wherein
the design data storage unit further stores a flag for identifying a piece of the design data used for configuring the content use circuit currently configured in the reconfigurable unit.

18. A content use method for use in a content use apparatus comprising: a reconfigurable unit operable to configure a circuit based on a piece of design data; a first judgment unit; a second judgment unit; and an acquisition unit, the content use method comprising the steps of:
judging, by the first judgment unit, whether a content use circuit has been configured in the reconfigurable unit, the content use circuit realizing a function relating to use of a content;
judging, by the second judgment unit, whether content use design data for configuring the content use circuit has been stored;
acquiring, by the acquisition unit, if the first judgment unit and the second judgment unit judge negatively, the content use design data from outside; and
configuring, by the reconfigurable unit, the content use circuit based on the acquired content use design data.

19. A computer program that operates in a content use apparatus comprising: a reconfigurable unit operable to configure a circuit based on a piece of design data; a first judgment unit; a second judgment unit; and an acquisition unit, the computer program comprising the steps of:
judging, by the first judgment unit, whether a content use circuit has been configured in the reconfigurable unit, the content use circuit realizing a function relating to use of a content;
judging, by the second judgment unit, whether content use design data for configuring the content use circuit has been stored;
acquiring, by the acquisition unit, if the first judgment unit and the second judgment unit judge negatively, the content use design data from outside; and
configuring, by the reconfigurable unit, the content use circuit based on the acquired content use design data.

20. A computer readable recording medium that stores the computer program of claim 19.

21. An integrated circuit comprising:
a reconfigurable unit operable to configure a circuit based on a piece of design data;
a first judgment unit operable to judge whether a content use circuit has been configured in the reconfigurable unit, the content use circuit realizing a function relating to use of a content;
a second judgment unit operable to judge whether content use design data for configuring the content use circuit has been stored; and
an acquisition unit operable, if the first judgment unit and the second judgment unit judge negatively, to acquire the content use design data from outside, wherein
the reconfigurable unit configures the content use circuit based on the acquired content use design data.
